(19) United States
(12) Patent Application Publication
(10) Pub. No.: US 2026/0054856 A1
(43) Pub. Date: Feb. 26, 2026

(54) METHOD AND APPARATUS FOR COLLECTING AND PROCESSING FLIGHT FUEL DATA, AND COMPUTER-READABLE MEDIUM

(71) Applicant: TRAVELSKY TECHNOLOGY LIMITED, Beijing (CN)

(72) Inventors: Xinran LI, Beijing (CN); Yang LI, Beijing (CN); Zheng CHEN, Beijing (CN); Zhongxing ZHAO, Beijing (CN); Yue HAN, Beijing (CN); Bingqian NIU, Beijing (CN); Wenxiao LI, Beijing (CN); Yazhong LIANG, Beijing (CN); Chao LI, Beijing (CN); Yulong ZHANG, Beijing (CN); Jiamian REN, Beijing (CN); Bo WANG, Beijing (CN)

(21) Appl. No.: 19/106,076

(22) PCT Filed: Sep. 14, 2023
(86) PCT No.: PCT/CN2023/118724

§ 371 Date: Feb. 24, 2025

(30) Foreign Application Priority Data
Sep. 14, 2022 (CN) 202211114114.X

(51) Int. Cl. B64F 5/60; G08G 5/32

(52) U.S. Cl. CPC B64F 5/60; G08G 5/32

(57) ABSTRACT

A method and apparatus for collecting and processing flight fuel data, and a computer-readable medium. The method includes: acquiring flight schedule information of a flight from a flight list; determining and acquiring flight fuel data matching the flight schedule information of the flight; collecting, by a pre-constructed data collection component, the flight schedule information of the flight and a matched flight fuel data based on a set data collection protocol; and determining a fuel load planning center of gravity based on pre-configured fuel calculation parameters and the matched flight fuel data, to obtain a center of gravity index value of the flight.

### CROSS-REFERENCE TO RELATED PATENT APPLICATIONS

The present disclosure is a U.S. national phase patent application of PCT/CN2023/118724 filed Sep. 14, 2023 and claims the priority of Chinese Patent Application 202211114114.X, filed in the China Patent Office on Sep. 14, 2022, and entitled “Method and Apparatus for Collecting and Processing Flight Fuel Data, and Computer-Readable Medium”, the entire contents of each of which are herein incorporated by reference.

### TECHNICAL FIELD

The present disclosure relates to the technical field of flight load planning, and in particular to a method and apparatus for collecting and processing flight fuel data, and a computer-readable medium.

### BACKGROUND

An aircraft (e.g., a civil aircraft) is a transport tool flying the air, and the aircraft requires load planning to achieve higher reliability, safety and a better balance state. The flight of the aircraft is implemented by overcoming the gravity of the earth, and for one aircraft, the maximum power of an engine, the maximum lift capable of wings of the aircraft can generate, the bearing capacity of a landing gear and the like have rated data, and these data are limits for enabling the aircraft to safely fly. The load planning of the aircraft is to allocate and calculate the load and balance of each flight of the aircraft during an operation process, that is, to reasonably and scientifically arrange the positions of passengers, luggage, cargoes and mails on the aircraft based on the characteristics of the center of gravity of the aircraft and related technical data, and to control fuel and the like to be within a reasonable range, thereby ensuring the flight safety of the aircraft.

The fuel is a power source in the air transport industry, and is a basis for ensuring that the aircraft completes a flight task. Before the aircraft takes off, an aircrew plans a safe range of the fuel based on a flight route, the weight of the aircraft and expected aviation fuel data of the aircraft. However, after taking off, the aircraft often encounters uncontrollable factors such as flying around in thunderstorm, circling flow control and re-flight, so that it is crucial to the normal flight of the flight to accurately calculate flight fuel data. On one hand, before every take-off of the flight, it is necessary for a dispatcher and the aircrew ensure that the fuel may meet the requirements of aircraft taxiing, aircraft flight segments, route maneuver and standby flights; and on the other hand, excessive fuel volume may cause problems such as cost rise and resource waste of an airline. In addition, it is also necessary to calculate a center of gravity index based on transmitted flight fuel data (e.g., the weight of flight fuel volume) in the load planning of the aircraft. The center of gravity index is a simplified description of the center of gravity of the aircraft, which is core result data for the calculation of the center of gravity, and only when the center of gravity index is within a reasonable range, it can be ensured that the flight may safely arrive at the destination.

A traditional flight fuel data transmission method relies on fax, telephone or other means to tell a load planner, and the load planner manually inputs the flight fuel data into a system, which leads to some problems: information update is not timely, and when the flight fuel volume changes, when timely notification is not performed or the dispatcher forgets to update the input, an error in the flight fuel data will be caused. Moreover, a traditional center of gravity index calculation method is not reasonable enough, such that it is difficult to perform accurate resource management and control and load planning control over the aircraft. Therefore, with the high-speed development of civil aviation and the year-by-year increasing flight numbers, the existing flight fuel data transmission method and center of gravity index calculation method cannot meet the requirements of rapid development of the civil aviation industry.

### SUMMARY

In view of this, the present disclosure provides a method and apparatus for collecting and processing flight fuel data, and a computer-readable medium, to solve at least part of shortcomings of the conventional technology in the aspects of transmission of flight fuel data and calculation of a center of gravity index based on the flight fuel data, and to better meet the requirements of rapid development of the civil aviation industry, and the like.

The solution is as follows:
a method for collecting and processing flight fuel data, including:
acquiring flight schedule information of a flight based on a pre-configured flight list; determining and acquiring flight fuel data matching the flight schedule information of the flight;
collecting, by a pre-constructed data collection component, the flight schedule information of the flight and a matched flight fuel data based on a set data collection protocol; and
determining a fuel load planning center of gravity based on pre-configured fuel calculation parameters and the matched flight fuel data, to obtain a center of gravity index value of the flight.

An apparatus for collecting and processing flight fuel data, including:
an acquisition unit, configured to acquire flight schedule information of a flight based on a pre-configured flight list;
a fuel data determination unit, configured to determine and acquire flight fuel data matching the flight schedule information of the flight;
a collection unit, configured to collect, by a pre-constructed data collection component, the flight schedule information of the flight and a matched flight fuel data based on a set data collection protocol; and
a center of gravity index determination unit, configured to determine a fuel load planning center of gravity based on pre-configured fuel calculation parameters and the matched flight fuel data, to obtain a center of gravity index value of the flight.

A computer-readable medium, storing a computer program thereon, wherein the computer program includes program codes for executing the method for collecting and processing flight fuel data provided in the present disclosure.

According to the above solutions, it can be seen that in the method and apparatus for collecting and processing flight fuel data, and the computer-readable medium provided in the present disclosure, the flight schedule information of the flight is acquired from the pre-configured flight list, the flight fuel data matching the flight schedule information of the flight is determined and acquired, the flight schedule information of the flight and the matched flight fuel data is collected by a pre-constructed data collection component based on the set data collection protocol, and the fuel load planning center of gravity is determined based on the pre-configured fuel calculation parameters and the matched flight fuel data, to obtain the center of gravity index value of the flight. Therefore, the present disclosure can automatically collect the fuel data without the need for manual query and input, thereby reducing the workload of a load planner, sending/transmitting the flight fuel data more quickly and conveniently, improving the efficiency of sending the flight fuel data, and reducing the influence of human factors on an aircraft load planning process.

In addition, by proposing and setting a non-standard refueling mode, and accurately determining an influence index (e.g., a take-off fuel volume influence index and a landing fuel volume influence index of each fuel tank) of a split fuel tank when a center of gravity index is calculated in the non-standard refueling mode, a fuel center of gravity calculation method is optimized, therefore resources can be managed and controlled more effectively, the weight and position of fuel and load planning control on its basis are controlled more accurately and safely, and the present disclosure has remarkable advantages in the aspects of improving the efficiency, accuracy and flight safety.

### BRIEF DESCRIPTION OF THE DRAWINGS

The above and other features, advantages and aspects of embodiments of the present disclosure will become more apparent in combination with the drawings and with reference to implementations below. Throughout the drawings, the same or similar reference signs indicate the same or similar elements. It should be understood that the drawings are schematic and that original members and elements are not necessarily drawn to scale.

FIG. 1 is a flowchart of a method for collecting and processing flight fuel data provided in the present disclosure;

FIG. 2 is a composition structure diagram of a system for performing load planning collection and automatically calculating a center of gravity index based on collected flight fuel data provided in the present disclosure;

FIG. 3 is a flowchart of a method for the system shown in FIG. 2 to perform load planning collection and center of gravity index calculation based on six modules thereof provided in the present disclosure; and

FIG. 4 is a composition structure diagram of an apparatus for collecting and processing flight fuel data provided in the present disclosure.

### DETAILED DESCRIPTION OF THE EMBODIMENTS

Hereinafter, embodiments of the present disclosure will be described in more detail with reference to the drawings. Although some embodiments of the present disclosure have been illustrated in the drawings, it should be understood that the present disclosure may be implemented in various forms and should not be construed as being limited to the embodiments set forth herein; and rather, these embodiments are provided to help understand the present disclosure more thoroughly and completely. It should be understood that the drawings and the embodiments of the present disclosure are for exemplary purposes only and are not intended to limit the protection scope of the present disclosure.

As used herein, the term “include” and variations thereof are open-ended inclusions, that is, “including, but not limited to”. The term “based on” is “based, at least in part, on”. The term “one embodiment” means “at least one embodiment”; the term “another embodiment” means “at least one additional embodiment”; and the term “some embodiments” means “at least some embodiments”. Relevant definitions of other terms will be given in the following description.

It should be noted that, concepts such as “first” and “second” mentioned in the present disclosure are only intended to distinguish different apparatuses, modules or units, and are not intended to limit the sequence or interdependence of functions executed by these apparatuses, modules or units.

It should be noted that, the modifiers such as “one” and “more” mentioned in the present disclosure are intended to be illustrative and not restrictive, and those skilled in the art should understand that the modifiers should be interpreted as “one or more” unless the context clearly indicates otherwise.

The embodiments of the present disclosure provide a method and apparatus for collecting and processing flight fuel data, and a computer-readable medium, to solve at least part of shortcomings of the conventional technology in the aspects of transmission of flight fuel data and calculation of a center of gravity index based on the flight fuel data, and to better meet the requirements of rapid development of the civil aviation industry, and the like.

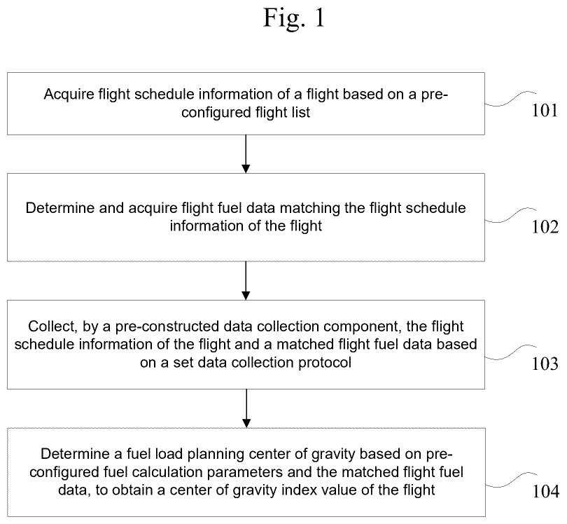

FIG. 1 illustrates a flowchart of a method for collecting and processing flight fuel data, and the method for collecting and processing flight fuel data provided in the present disclosure includes the following processing processes:
at step of 101: acquiring flight schedule information of a flight based on a pre-configured flight list.

In implementation, the processing logic of the method provided in the present disclosure may be implemented by developing/constructing an application system in advance.

In the present embodiment, a user, for example, a load planner, pre-configures the flight list, in an embodiment, the process of pre-configuring the flight list includes: querying a flight matching a preset flight query condition, and adding the flight into the flight list.

For example, the load planner logs in a front-end page of a pre-established load planning system (LDP), and takes information such as a flight number and a time of departure as a query condition, to query the flight based on the information such as the flight number and the time of departure, and to add the flight into the flight list.

On this basis, a system may automatically acquire the flight schedule information of the flight based on the flight list. The acquired flight schedule information includes, but is not limited to, necessary information of the flight, such as a flight number, a tail number, an aircraft type, a complete route (an airport of departure, a landing airport, and a stopover airport), a current flight segment, a flight nature, a scheduled time of departure (STD), an estimated time of departure (when there is), an actual time of departure (when there is), a scheduled time of arrival (STA), an estimated time of arrival (when there is), and an actual time of arrival (when there is).

At step of 102: determining and acquiring flight fuel data matching the flight schedule information of the flight.

Then, the system further determines and acquires the flight fuel data (e.g., fuel volume data such as take-off fuel volume) matching the flight schedule information of the flight.

At step of 103: collecting, by a pre-constructed data collection component, the flight schedule information of the flight and a matched flight fuel data based on a set data collection protocol.

In the embodiments of the present disclosure, a fuel data collection component (referred to as the “data collection component”) is pre-constructed, and the pre-constructed data collection component may collect the flight schedule information of the flight and the matched flight fuel data based on a preset condition and period for updating the load planning flight, and stipulated data content and format of the flight schedule information and fuel volume data during information transmission.

Therefore, by continuously and automatically acquiring the flight schedule information of the flight based on the flight list, the system may continuously trigger the automatic and synchronous collection of the flight schedule information of the flight and the matched flight fuel data based on the preset condition and period for updating the load planning flight and based on the stipulated data content and format of the flight schedule information and the fuel volume data during information transmission.

At step of 104: determining a fuel load planning center of gravity based on pre-configured fuel calculation parameters and the matched flight fuel data, to obtain a center of gravity index value of the flight.

In an embodiment, the process of pre-configuring the fuel calculation parameters includes: adding setting items of aircraft static data and generating a period of validity, wherein the flight takes effect within the period of validity; and configuring and storing aircraft fuel calculation parameters in the setting items of the aircraft static data. In an embodiment, a static data maintainer can add the setting items of the aircraft static data on the system and generate the period of validity, wherein the flight takes effect within the period of validity; and the aircraft static data maintainer stores the aircraft fuel calculation parameters in the setting items of the static data.

The pre-configured fuel calculation parameters include, but are not limited to, a table name of a split fuel tank, a refueling mode, tail fuel tank data, taxi allowance data, ballast fuel, a fuel volume density, a fuel volume density range, etc.

On this basis, in the present step, the fuel load planning center of gravity is determined based on the pre-configured fuel calculation parameters and the matched flight fuel data, to obtain the center of gravity index value of the flight.

The center of gravity index is a simplified description of the center of gravity of an aircraft, and is core result data of center of gravity calculation. The center of gravity index mainly includes: Loading Index at Zero Fuel Weight (LIZFW), Loading Index at Take-Off Weight (LITOW), Loading Index at Landing Air Weight (LILAW), and Loading Index at Dead Load Weight (LIDLW). Only when the center of gravity index is within a reasonable range, the flight may be protected to safely arrive at the destination.

The Loading Index at Take-Off Weight may also be referred to as a take-off fuel volume influence index, and the Loading Index at Landing Air Weight may also be referred to as a landing fuel volume influence index. In the embodiments of the present disclosure, when the center of gravity index is calculated, the calculation of the take-off fuel volume influence index and the landing fuel volume influence index is mainly taken as an example for illustration.

In the conventional technology, in order to reduce service calculation, a part of airlines may use a set fixed fuel volume for calculation, but it is discovered in researches that passengers and cargoes of a flight are not fixed, and when the same fixed fuel volume value is used, the accuracy of a calculation result is affected. In addition, it is also discovered that only the influence of the overall fuel on the center of gravity of the flight is calculated in the conventional technology, it is difficult to accurately determine which specific fuel tank, and thus it is difficult to accurately decrease or increase the fuel of which fuel tank, so that it is difficult to perform accurate resource control and load planning control on the aircraft.

In view of the above problems, in the present disclosure, the calculation of the center of gravity index is divided into two modes, one mode is to calculate the center of gravity index based on a standard refueling mode, and the other mode is to calculate the center of gravity index based on a non-standard refueling mode, wherein in the calculation based on the non-standard refueling mode, the influence index (e.g., the take-off fuel volume influence index and the landing fuel volume influence index of each fuel tank) of a split fuel tank may be further accurately calculated, to optimize the fuel center of gravity calculation method, and it is convenient to accurately decrease or increase the fuel of a fuel tank.

Correspondingly, in the step of 104, when the fuel load planning center of gravity is calculated to obtain the center of gravity index value of the flight, the step of 104 may be implemented as:
determining, in the standard refueling mode, the fuel load planning center of gravity based on corresponding fuel calculation parameters and the matched flight fuel data in the standard refueling mode; and
determining, in the non-standard refueling mode, the fuel load planning center of gravity based on corresponding fuel calculation parameters and the matched flight fuel data in the non-standard refueling mode.

In an embodiment, the process of determining, in the standard refueling mode, the fuel load planning center of gravity based on the corresponding fuel calculation parameters and the matched flight fuel data in the standard refueling mode includes:
11) in response to a take-off fuel volume of a tail fuel tank being not separately provided, determining a take-off fuel volume influence index of the aircraft based on total take-off fuel volume data, a fuel density and a flight standard refueling total fuel center of gravity index data table;
12) in response to the take-off fuel volume of the tail fuel tank being separately provided, calculating a take-off fuel volume influence index of the tail fuel tank based on the take-off fuel volume of the tail fuel tank and data in an aircraft tail fuel tank fuel center of gravity index data table, and determining take-off fuel volume influence indexes corresponding to the other fuel tanks by using the total take-off fuel volume of other fuel tanks which is determined based on the total take-off fuel volume and the take-off fuel volume of the tail fuel tank;
13) in response to the aircraft used by the flight not corresponding to data in a landing-dedicated fuel volume center of gravity index table, determining a total landing fuel volume based on the total take-off fuel volume and flight fuel consumption, and determining a landing fuel volume influence index of the aircraft based on the total landing fuel volume and the fuel density and based on the flight standard refueling total fuel center of gravity index data table; and
14) in response to the aircraft used by the flight corresponding to the data in the landing-dedicated fuel volume center of gravity index table, determining the landing fuel volume influence index of the aircraft according to the data in the landing-dedicated fuel volume center of gravity index table.

That is, in the standard refueling mode, the center of gravity index is calculated mainly based on the total fuel volume data (e.g., total take-off fuel volume data, total landing fuel volume data, and the like) of the aircraft, and the influence index (e.g., the take-off fuel volume influence index of a split fuel tank corresponding to each fuel tank, and the landing fuel volume influence index of the split fuel tank) corresponding to each fuel tank of the aircraft cannot be correspondingly obtained.

In an embodiment, the process of determining, in the non-standard refueling mode, the fuel load planning center of gravity based on the corresponding fuel calculation parameters and the matched flight fuel data in the non-standard refueling mode includes:
21) in response to the take-off fuel volume of the tail fuel tank being not separately provided, determining a take-off fuel volume influence index of each fuel tank based on the take-off fuel volume of the split fuel tank of each fuel tank, and determining the take-off fuel volume influence index of the aircraft based on the take-off fuel volume influence index of each fuel tank;
22) in response to the take-off fuel volume of the tail fuel tank being separately provided, determining the take-off fuel volume influence index of the tail fuel tank based on the take-off fuel volume of the tail fuel tank and a fuel center of gravity index data table of the tail fuel tank, and determining the take-off fuel volume influence indexes corresponding to the other fuel tanks by using the total take-off fuel volume of other fuel tanks which is determined based on the total take-off fuel volume and the take-off fuel volume of the tail fuel tank; and
23) determining the landing fuel volume influence index of each fuel tank based on the landing fuel volume of the split fuel tank of each fuel tank, and determining the landing fuel volume influence index of the aircraft based on the landing fuel volume influence index of each fuel tank.

Compared with the standard refueling mode, in the non-standard refueling mode, the center of gravity index is calculated mainly based on the fuel data of the split fuel tank of each fuel tank of the aircraft, for example, the take-off fuel volume data and the landing fuel volume data of each fuel tank. The non-standard refueling mode including: calculating the influence index (e.g., the take-off fuel volume influence index of the split fuel tank corresponding to each fuel tank, and the landing fuel volume influence index of the split fuel tank) of the split fuel tank of each fuel tank, and further calculating the influence index of the entire aircraft composed of all fuel tanks, such as the take-off fuel volume influence index and the landing fuel volume influence index of the aircraft, based on the influence index of the split fuel tank of each fuel tank. In this way, the center of gravity index of a fuel tank is accurately calculated to optimize the fuel center of gravity calculation method, so that resources can be managed and controlled more efficiently, and the weight and position of the fuel are controlled more accurately and safely.

On the basis of calculating the center of gravity index value of the flight based on the pre-configured fuel calculation parameters, the flight fuel data and corresponding modes (the standard refueling mode and the non-standard refueling mode), the calculated center of gravity index value of the flight may be further presented in a graphical form to perform resource management and control on the aircraft based on the presentation result and to more accurately and safely control the weight and position of the fuel. For example, the load planner visually finds an unreasonable load planning fuel consumption position based on the graphical presentation result, and performs fuel increase, fuel reduction and the like on the fuel tank at the corresponding position.

According to the above solutions, it can be seen that in the method for collecting and processing flight fuel data, the flight schedule information of the flight is acquired from the pre-configured flight list, the flight fuel data matching the flight schedule information of the flight is determined and acquired, the flight schedule information of the flight and the matched flight fuel data is collected by a pre-constructed data collection component based on the set data collection protocol, and the fuel load planning center of gravity is determined based on the pre-configured fuel calculation parameters and the matched flight fuel data, to obtain the center of gravity index value of the flight. Therefore, the present disclosure can automatically collect the fuel data without the need for manual query and input, thereby reducing the workload of the load planner, sending/transmitting the fuel data more quickly and conveniently, improving the efficiency of sending the flight fuel data, and reducing the influence of human factors on an aircraft load planning process.

In addition, by proposing and setting the non-standard refueling mode, and accurately determining the influence index (e.g., the take-off fuel volume influence index and the landing fuel volume influence index of each fuel tank) of the specific split fuel tank when the center of gravity index is calculated in the non-standard refueling mode, the fuel center of gravity calculation method is optimized, therefore resources can be managed and controlled more effectively, the weight and position of fuel are controlled more accurately and safely, and the present disclosure has remarkable advantages in the aspects of improving the efficiency, accuracy and flight safety.

For a clear understanding of the solutions of the present disclosure, a detailed description will be given below in a example.

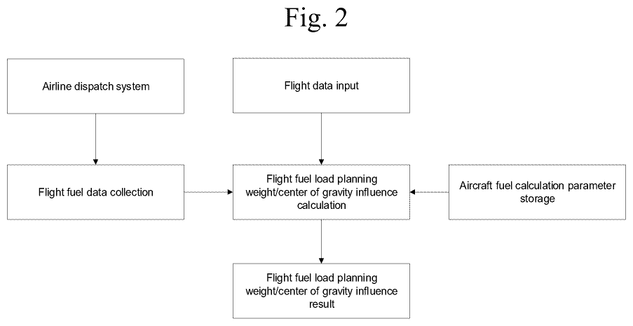

In the present example, the processing logic of the method in the present disclosure is implemented by constructing a “system for performing load planning collection and automatically calculating a center of gravity index based on collected flight fuel data”. Referring to the composition structure of the system shown in FIG. 2, the system is mainly composed of six modules, which are an airline dispatch system, flight fuel data collection, flight data input, aircraft fuel calculation parameter storage, flight fuel load planning weight/center of gravity influence calculation, and flight fuel load planning weight/center of gravity influence result.

Each module may be implemented in a component form.

The functions of the modules implemented based on the component form are respectively as follows:
an airline dispatch system module component: a dispatch system is configured to acquire flight schedule information and match fuel data according to a flight list, the flight schedule information mainly includes necessary information of the flight, such as a flight number, a tail number, an aircraft type, a complete route (an airport of departure, a landing airport, and a stopover airport), a current flight segment, a flight nature, a scheduled time of departure (STD), an estimated time of departure (when there is), an actual time of departure (when there is), a scheduled time of arrival (STA), an estimated time of arrival (when there is), and an actual time of arrival (when there is), and real-time synchronization between the flight fuel data and an operating system is ensured by the system.

A flight fuel data collection module component, configured to receive data of the dispatch system, that is, acquire the data from the dispatch system, the dispatch system and the flight fuel data collection module component formulate a protocol in advance to determine a condition and period of the dispatch system for updating a load planning flight, determine the data content and format of the flight schedule information and the fuel volume data during information transmission, and to determine a format and an error code for message sending. Therefore, the collection module component collects, in a message mode, the flight schedule information of the flight and the matched flight fuel data based on the preset condition and period for updating the load planning flight and the stipulated data content and format of the flight schedule information and the fuel volume data during information transmission, and reports an error based on the error code when the error occurs.

A flight data input module component: a control body of the module is a load planner, the load planner may add the flight to the flight list through a front-end interface of the system, and acquire the fuel volume data based on the flight schedule information.

An aircraft fuel calculation parameter storage module component: the control body of the module is a static data maintainer, and the maintainer needs to select an airline and a fleet to enter an aircraft static data page, open a related label page, such as a Fuel label page under an Aircraft Information menu, and define calculation parameters of aircraft fuel. After successful addition, a configuration rule and the fuel volume data will be used during flight fuel load planning weight (center of gravity) influence calculation.

A flight fuel load planning weight/center of gravity influence calculation module component: a background calculates a specific fuel load planning weight/center of gravity value according to fuel data transmitted from the aircraft fuel calculation parameter storage module component and the dispatch system, so as to obtain center of gravity index data in a corresponding mode (for example, standard refueling or non-standard refueling).

A flight fuel load planning weight/center of gravity influence result module component, configured to present a calculation result (i.e., the center of gravity index data) in a graphical form.

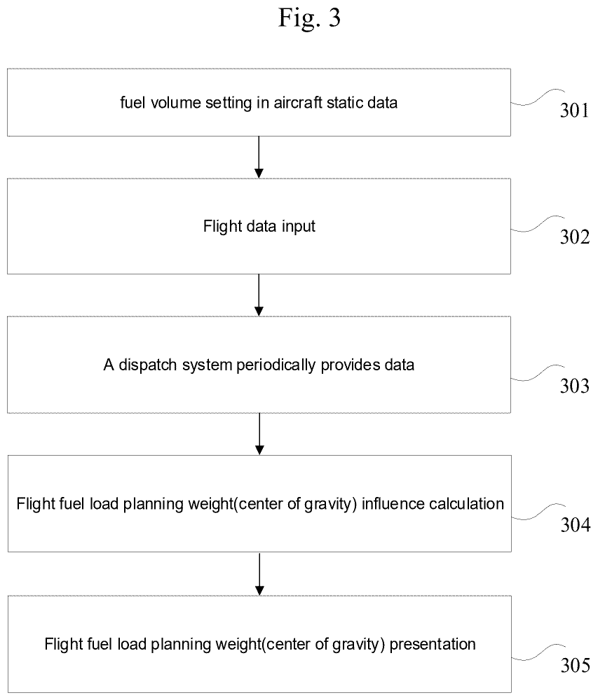

Referring to FIG. 3, the flow of a method for the system to perform load planning collection and center of gravity index calculation based on the six modules is as follows:

at step of 301: the static data maintainer adds setting items of aircraft static data and generates a period of validity, and the flight takes effect within the period of validity; and the static data maintainer stores aircraft fuel calculation parameters in the setting items of the aircraft static data (a Fuel label page).

Wherein there are many fuel calculation parameters, including, but not limited to: a table name of a split fuel tank, a refueling mode, tail fuel tank data, taxi allowance data, ballast fuel, a fuel volume density, a fuel volume density range, etc.

At step of 302: the load planner logs in the front-end page of the LDP, queries a flight based on information such as a flight number and a time of departure, and adds the flight to a flight list.

At step of 303: the dispatch system acquires flight schedule information, and periodically transmits fuel data to a fuel data collection port based on flight information.

At step of 304: the background calculates a related center of gravity index based on the obtained fuel data through the flight fuel load planning weight/center of gravity influence calculation module component.

At step of 305: the obtained fuel data is presented on the front-end page, and the load planner may directly check values and may also adjust the data based on actual situations. The center of gravity and the center of gravity index calculated by the flight fuel load planning weight/center of gravity influence calculation module component are presented in the graphical form, so that the load planner can intuitively find an unreasonable load planning fuel consumption position for adjustment and control.

In combination with the above description, it can be seen that in the present example, for different usage situations of users for load planning information, the users are mainly divided into two types, that is, the static data maintainer and the load planner, wherein the static data maintainer mainly completes the configuration of a static data module based on requirements, including input, modification, check and the like of all information of the static data. The load planner is mainly responsible for checking the fuel data, adjusting the fuel weight, performing flight configuration and other works.

The mode for the system to perform load planning collection and automatically calculating the center of gravity index based on the collected flight fuel data, one mode is based on the standard refueling mode, the other mode is based on the non-standard refueling mode, and the implementation process of performing load planning collection and automatically calculating the center of gravity index based on the collected flight fuel data will be described below in detail in the present example.

### (1) Standard Fueling Mode

In the mode, it is taken as an example for introduction that in the aircraft static data, the airline is the airline MU (China Eastern Airlines) and the fleet is 737-800. The process of performing, in the standard refueling mode, load planning collection and automatically calculating the center of gravity index based on the collected flight fuel data includes:
   at step of 1: the static data maintainer adds the setting items of the aircraft static data:
      1) log in the front end of the LDP;
      2) open an “Aircraft Static Data” page, select the airline MU, and click on a “Create Fleet” button to increase the setting items;
      3) corresponding parameters include information such as a default fuel volume density, a default seat map, a default aircraft type, a default fuel tank and containerized labeling, a period of validity may be automatically generated in the settings of the present disclosure, default settings start to be valid from the current date, and the data only takes effect for flights conforming to the range of the period of validity; and
      4) click on “Save” to save the configuration in a database.
   At step of 2: the static data maintainer changes the setting items of the aircraft static data:
      1) open the “Aircraft Static Data” page, and select the airline MU and the fleet (737-800);
      2) set take-off fuel volume data and a used fuel density, display a fuel weight (Weight) and a center of gravity index (Index) in the flight standard refueling total fuel center of gravity index data table, and set fuel volume table data of the tail fuel tank in the aircraft tail fuel tank fuel center of gravity index data table; and
      3) click on “Save” to save the configuration in the database.
   At step of 3: the load planner adds the flight into the flight list:
      1) click on a new-generation load planning whole-flow page;
      2) click on a flight task button;
      3) click on a new button in a pop-up flight list dialog box;
      4) add time of departure (moment), arrival station and fleet (supporting fuzzy query) screening query conditions in a search box in the pop-up dialog box of adding a new flight to the list; and
      5) add the queried flight into the flight list.
   At step of 4: transmit the fuel data:
      1) based on a protocol, the dispatch system automatically pushes the fuel data to the background through the flight fuel data collection module component, and if necessary, the load planner may also actively query (click on a latest flight fuel data button) the fuel data, and when the fuel data is automatically updated, the fuel data collection module component sends a data update notification to the load planner.
   At step of 5: calculate the center of gravity index based on the fuel data:
      1) calculate the take-off fuel volume influence index: \hat{1} the total fuel volume data is used, that is, the flight does not respectively input the fuel volume based on each fuel tank, in this case, the flight standard refueling total fuel center of gravity index data table is used to determine the take-off fuel volume influence index of the aircraft based on the take-off fuel volume (which refers to the total take-off fuel volume) data and the used fuel density, specifically, matched data may be directly discovered by table look-up, and when the matched data cannot be directly discovered in the flight standard refueling total fuel center of gravity index data table, the take-off fuel volume influence index of the aircraft may be calculated by using a linear interpolation mode, including: recording data less than the take-off fuel volume in the table as X1, recording the corresponding influence index as Y1, recording data greater than the take-off fuel volume in the table as X2, recording the corresponding influence index as Y2, and using the formula Y=[(Y2−Y1)/(X2−X1)]*(X−X1)+Y1 to calculate the take-off fuel volume influence index of the aircraft, wherein X is the take-off fuel volume; and \hat{2} in response to the take-off fuel volume of the tail fuel tank being input separately (i.e., data is set in the aircraft tail fuel tank fuel center of gravity index data table), the take-off fuel volume influence index of the tail fuel tank is calculated by using the data in the aircraft tail fuel tank fuel center of gravity index data table, the other fuel volume data is calculated after the take-off fuel volume of the tail fuel tank is subtracted from the take-off fuel volume, and the calculation method is the same as that in \hat{1}; and
      2) calculate the landing fuel volume influence index: \hat{1} the total fuel volume data is used, the flight fuel consumption is subtracted from the take-off fuel volume (which refers to the total take-off fuel volume) to calculate the landing fuel volume (i.e., total landing fuel volume), the landing fuel volume influence index of the aircraft is determined based on the landing fuel volume data, the used fuel density and the flight standard refueling total fuel center of gravity index data table, specifically, matched data may be directly discovered by table look-up, and in response to the matched data cannot be directly discovered in the flight standard refueling total fuel center of gravity index data table, the landing fuel volume influence index of the aircraft may be calculated by using the linear interpolation mode, the interpolation principle is the same as the interpolation principle for calculating the take-off fuel volume influence index of the aircraft, and thus reference may be made to the interpolation principle for calculating the take-off fuel volume influence index of the aircraft; and \hat{2} in response to the aircraft used by the flight has the data in the landing-dedicated fuel volume center of gravity index table, the landing fuel volume influence index of the aircraft is calculated by using the data in the landing-dedicated fuel volume center of gravity index table, and the calculation method is the same as the calculation method of the landing fuel volume influence index \hat{1}.
   At step of 6: the load planner checks the calculation result of the fuel data:
      1) the load planner may directly check the transmitted fuel data through the front-end interface, and may also check a fuel volume center of gravity map.

### (2) Non-Standard Fueling Mode

In the mode, it is still taken as an example for introduction that in the aircraft static data, the airline is the airline MU (China Eastern Airlines) and the fleet is 737-800. In the non-standard refueling mode, the process of performing load planning collection and automatically calculating the center of gravity index based on the collected flight fuel data includes:
at step of 1: the static data maintainer adds the setting items of the aircraft static data:
   1) log in the front end of the LDP;
   2) open the “Aircraft Static Data” page, select the airline MU, and click on the “Create Fleet” button to increase the setting items;
   3) corresponding parameters include information such as the default fuel volume density, the default seat map, the default aircraft type, the default fuel tank and containerized labeling, the period of validity may be automatically generated in the settings of the present disclosure, default settings start to be valid from the current date, and the data only takes effect for flights conforming to the range of the period of validity; and
   4) click on “Save” to save the configuration in the database.
At step of 2: the static data maintainer changes the setting items of the aircraft static data:
   1) open the “Aircraft Static Data” page, and select the airline MU and the fleet (737-800);
   2) set a center of gravity index table of each split fuel tank, input the fuel weight (Weight) and the center of gravity index (Index) in the fuel center of gravity index table of each split fuel tank, if an independent fuel tank usage mode is a total fuel volume mode, that is, the fuel volume includes taxi allowance, the fuel consumption sequence and the taxiing fuel volume of the split fuel tanks may be defined by using a taxi allowance rule; and
   3) click on “Save” to save the configuration in the database.
At step of 3: the load planner adds the flight into the flight list:
   1) click on the new-generation load planning whole-flow page;
   2) click on the flight task button;
   3) click on the new button in the pop-up flight list dialog box;
   4) add time of departure (moment), arrival station and fleet (supporting fuzzy query) screening query conditions in the search box in the pop-up dialog box of adding a new flight to the list; and
   5) add the queried required flight into the flight list.
At step of 4: transmit the fuel data:
   1) based on the protocol, the dispatch system automatically pushes the fuel data to the background through the flight fuel data collection module component, and if necessary, the load planner may also actively query the fuel data.
At step of 5: calculate the center of gravity index based on the fuel data:
   1) calculate the take-off fuel volume influence index: \hat{1} the fuel volume of each fuel tank is input, the take-off fuel volume influence index of each fuel tank is calculated in a fuel volume table of the split fuel tank based on the fuel density and the table name of the fuel tank, if the independent fuel tank usage mode is the total fuel volume mode, the take-off fuel volume each fuel tank should be determined based on a taxi allowance rule definition and the taxi allowance, in response to the fuel consumption sequence being not defined in the taxi allowance rule definition, the taxi allowance is averagely allocated to each fuel tank (optionally, a remainder is placed in the last fuel tank in the case of aliquant), the influence index of each fuel tank is summed to obtain the take-off fuel volume influence index, and the calculation method of the fuel volume influence index of each fuel tank is linear interpolation; \hat{2} in response to the take-off fuel volume of the tail fuel tank being input separately (data is set in the aircraft tail fuel tank fuel center of gravity index data table), the take-off fuel volume influence index of the tail fuel tank is calculated by using the data in the aircraft tail fuel tank fuel center of gravity index data table, the other fuel volume data is calculated after the take-off fuel volume of the tail fuel tank is subtracted from the take-off fuel volume, and the calculation method is the same as the calculation method of the take-off fuel volume influence index in \hat{1} in this mode; and it should be noted that, the taxi allowance is averagely allocated to each fuel tank (optionally, the remainder is placed in the last fuel tank in the case of aliquant), but the tail fuel tank is not included; and
   2) calculate the landing fuel volume influence index: \hat{1} the landing fuel volume data of each fuel tank is input respectively, the landing fuel volume influence index of each fuel tank is calculated in the fuel volume table of the split fuel tank based on the fuel density and the name of the fuel tank, the landing fuel volume influence index of each fuel tank is summed to obtain the landing fuel volume influence index of the aircraft, and the calculation method of the landing fuel volume influence index of each fuel tank is linear interpolation.
At step of 6: the load planner checks the calculation result of the fuel data:
   1) the load planner may directly check the transmitted fuel data through the front-end interface, and may also check the fuel volume center of gravity map.

It should be noted that the center of gravity Index=W*(Balance Arm-Reference Arm)/C+K, wherein the Balance Arm is a reference line value, K is a constant for making the index be not negative, and C is a conversion constant of the Reference Arm and the Index. The center of gravity index may be obtained based on W (weight) and the Balance Arm.

In the calculation of the take-off fuel volume influence index and the landing fuel volume influence index, in response to the flight has a balance fuel volume and the fuel tank where the balance fuel volume is located being input, and the take-off fuel volume/landing fuel volume is also input based on each fuel tank, when the take-off fuel volume influence index/landing fuel volume influence index is calculated, for the fuel tank where the balance fuel volume is located, the balance fuel volume should be added with the take-off fuel volume/landing fuel volume, the influence index of the fuel tank is then calculated, and the influence index calculated according to the balance fuel volume is subtracted to serve as the take-off fuel volume influence index of the fuel tank; and in response to both the fuel volume density and the fuel volume density range when the fuel volume center of gravity data being defined, a fuel volume density is preferably matched, and when there is no fuel volume density data, a fuel volume table corresponding to the fuel volume density range is selected.

It should be noted that the flowcharts and block diagrams in the drawings illustrate system architectures, functions and operations of possible implementations of systems and methods according to various embodiments of the present disclosure. In this regard, each block in the flowcharts or block diagrams may represent a part of a module, a program segment, or a code, which includes one or more executable instructions for implementing logical functions. It should also be noted that, in some alternative implementations, the functions annotated in the blocks may occur out of the sequence labeled in the drawings. For example, two blocks shown in succession may, in fact, be executed substantially in parallel, or the blocks may sometimes be executed in a reverse sequence, depending upon the functions involved. It should also be noted that each block in the block diagrams and/or flowcharts, and combinations of the blocks in the block diagrams and/or flowcharts may be implemented by dedicated hardware-based systems for executing specified functions or operations, or combinations of dedicated hardware and computer instructions.

Although various operations are described in a particular order, this should not be understood as requiring that these operations are executed in the particular order shown or in a sequential order. In certain environments, multitasking and parallel processing may be advantageous.

It should be understood that, the steps recorded in the method embodiments of the present disclosure may be executed in different sequences and/or in parallel. In addition, the method embodiments may include additional steps and/or omit executing the steps shown. The scope of the present disclosure is not limited in this respect.

Computer program codes for executing the operations of the present disclosure may be written in one or more programming languages or combinations thereof. The programming languages include, but are not limited to, object node-oriented programming languages, such as Java, Smalltalk, C++, and conventional procedural programming languages, such as the “C” language or similar programming languages. The program codes may be executed entirely on a user computer, executed partly on the user computer, executed as a stand-alone software package, executed partly on the user computer and partly on a remote computer, or executed entirely on the remote computer or a server. In the case involving the remote computer, the remote computer may be connected to the user computer through any type of network, including a local area network (LAN) or a wide area network (WAN), or it may be connected to an external computer (e.g., through the Internet using an Internet service provider).

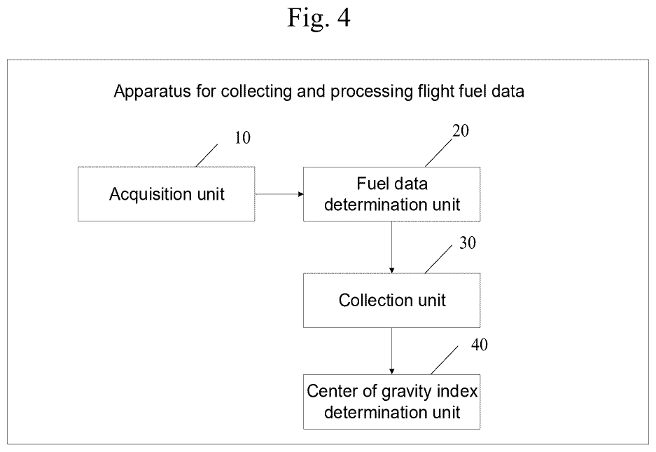

Corresponding to the above method for collecting and processing flight fuel data, an embodiment of the present disclosure further discloses an apparatus for collecting and processing flight fuel data, and a composition structure of the apparatus is shown in FIG. 4, including:
an acquisition unit 10, configured to acquire flight schedule information of a flight based on a pre-configured flight list;
a fuel data determination unit 20, configured to determine and acquire flight fuel data matching the flight schedule information of the flight;
a collection unit 30, configured to collect, by a pre-constructed data collection component, the flight schedule information of the flight and a matched flight fuel data based on a set data collection protocol; and
a center of gravity index determination unit 40, configured to determine a fuel load planning center of gravity according to pre-configured fuel calculation parameters and the matched flight fuel data, to obtain a center of gravity index value of the flight.

In one embodiment, the apparatus further includes a configuration module, configured to pre-configure the flight list. The process of the configuration module pre-configuring the flight list includes: querying a flight matching a preset flight query condition; and adding the flight into the flight list.

In one embodiment, the configuration module is further configured to pre-configure the fuel calculation parameters. The process of the configuration module pre-configuring the fuel calculation parameters includes: adding setting items of aircraft static data, and generating a period of validity, wherein the flight takes effect within the period of validity; and configuring and storing aircraft fuel calculation parameters in the setting items of the aircraft static data.

In one embodiment, the collection unit 30 is configured to:
collect, by the pre-constructed data collection component, the flight schedule information of the flight and the matched flight fuel data based on a preset condition and period for updating a load planning flight, and data content and a format of the flight schedule information and fuel volume data during information transmission.

In one embodiment, the center of gravity index determination unit 40 is configured to:
determine, in a standard refueling mode, the fuel load planning center of gravity based on corresponding fuel calculation parameters and the matched flight fuel data in the standard refueling mode; and
determine, in a non-standard refueling mode, the fuel load planning center of gravity based on corresponding fuel calculation parameters and the matched flight fuel data in the non-standard refueling mode.

In one embodiment, when determining, in the standard refueling mode, the fuel load planning center of gravity according to the corresponding fuel calculation parameters and the matched flight fuel data in the standard refueling mode, the center of gravity index determination unit 40 is configured to:
in response to a take-off fuel volume of a tail fuel tank being not separately provided, determine a take-off fuel volume influence index of an aircraft based on total take-off fuel volume data and a fuel density, and based on a flight standard refueling total fuel center of gravity index data table;
in response to the take-off fuel volume of the tail fuel tank being separately provided, calculate a take-off fuel volume influence index of the tail fuel tank based on the take-off fuel volume of the tail fuel tank and data in an aircraft tail fuel tank fuel center of gravity index data table, and determine take-off fuel volume influence indexes corresponding to the other fuel tanks by using the total take-off fuel volume of other fuel tanks which is determined based on the total take-off fuel volume and the take-off fuel volume of the tail fuel tank;
in response to an aircraft used by the flight not corresponding to data in a landing-dedicated fuel volume center of gravity index table, determine a total landing fuel volume based on the total take-off fuel volume and flight fuel consumption, and determine a landing fuel volume influence index of the aircraft based on the total landing fuel volume, the fuel density, and the flight standard refueling total fuel center of gravity index data table; and
in response to the aircraft used by the flight corresponds to the data in the landing-dedicated fuel volume center of gravity index table, determine the landing fuel volume influence index of the aircraft based on the data in the landing-dedicated fuel volume center of gravity index table.

In one embodiment, when determining, in the non-standard refueling mode, the fuel load planning center of gravity based on the corresponding fuel calculation parameters and the matched flight fuel data in the non-standard refueling mode, the center of gravity index determination unit 40 is configured to:
in response to the take-off fuel volume of the tail fuel tank being not separately provided, determine the take-off fuel volume influence index of each fuel tank based on the take-off fuel volume of a split fuel tank of each fuel tank, and determine the take-off fuel volume influence index of the aircraft based on the take-off fuel volume influence index of each fuel tank;
in response to the take-off fuel volume of the tail fuel tank being separately provided, determine the take-off fuel volume influence index of the tail fuel tank based on the take-off fuel volume of the tail fuel tank and the fuel center of gravity index data table of the tail fuel tank, and determine the take-off fuel volume influence indexes corresponding to the other fuel tanks by using the total take-off fuel volume of other fuel tanks which is determined based on the total take-off fuel volume and the take-off fuel volume of the tail fuel tank; and
determine the landing fuel volume influence index of each fuel tank based on the landing fuel volume of the split fuel tank of each fuel tank, and determine the landing fuel volume influence index of the aircraft based on the landing fuel volume influence index of each fuel tank.

In one embodiment, the apparatus further includes a presentation unit, configured to present the center of gravity index value of the flight in a graphical form.

For the apparatus for collecting and processing flight fuel data provided in the embodiment of the present disclosure, since it corresponds to the method for collecting and processing flight fuel data provided in the above method embodiments, the description is relatively simple, and for related similarities, reference may be made to the description of the above method embodiments, and thus details are not described herein again.

The units involved in the described embodiments of the present disclosure may be implemented in a software or hardware manner. The names of the units do not constitute limitations of the units themselves in a certain case, for example, a first acquisition unit may also be described as “a unit for acquiring at least two Internet protocol addresses”.

The functions described herein above may be executed, at least in part, by one or more hardware logical components. For example, without limitation, example types of the hardware logical components that may be used include: a field programmable gate array (FPGA), an application specific integrated circuit (ASIC), an application specific standard product (ASSP), a system on chip (SOC), a complex programmable logic device (CPLD), and so on.

The present disclosure further provides a computer-readable medium, storing a computer program thereon, wherein the computer program includes program codes for executing the method for collecting and processing flight fuel data provided in any method embodiment mentioned above.

In the context of the present disclosure, the computer-readable medium (a machine-readable medium) may be a tangible medium, which may include or store a program for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above content. More examples of the machine-readable storage medium would include an electrical connection based on at least one wire, a portable computer disk, a hard disk, a random access memory (RAM), a read-only memory (ROM), an erasable programmable read-only memory (EPROM or a flash memory), an optical fiber, a compact disc-read-only memory (CD-ROM), an optical storage device, a magnetic storage device, or any suitable combination of the above content.

It should be noted that, the computer-readable medium described above in the present disclosure may be either a computer-readable signal medium or a computer-readable storage medium, or any combination of the two. The computer-readable storage medium may be, for example, but is not limited to, an electrical, magnetic, optical, electromagnetic, infrared, or semiconductor system, apparatus or device, or a combination of any of the above. More examples of the computer-readable storage medium may include, but are not limited to: an electrical connection having at least one wire, a portable computer magnetic disk, a hard disk, a random access memory (RAM), a read-only memory (ROM), an erasable programmable read-only memory (EPROM or a flash memory), an optical fiber, a compact disc read-only memory (CD-ROM), an optical storage device, a magnetic storage device, or any suitable combination of the above content. In the present disclosure, the computer-readable storage medium may be any tangible medium that includes or stores a program, and the program may be used by or in combination with the instruction execution system, apparatus or device. In the present disclosure, the computer-readable signal medium may include a data signal that is propagated in a baseband or used as part of a carrier, wherein the data signal carries computer-readable program codes.

Such propagated data signal may take many forms, including, but not limited to, electromagnetic signals, optical signals, or any suitable combination thereof. The computer-readable signal medium may also be any computer-readable medium other than the computer-readable storage medium, and the computer-readable signal medium may send, propagate or transmit the program for use by or in combination with the instruction execution system, apparatus or device. Program codes included on the computer-readable medium may be transmitted with any suitable medium, including, but not limited to: an electrical wire, an optical cable, RF (Radio Frequency), and the like, or any suitable combination thereof.

The computer-readable medium may be included in an electronic device; and it may also be present separately and is not assembled into the electronic device.

In summary, according to at least one embodiment of the present disclosure, the present disclosure provides a method for collecting and processing flight fuel data, including:
acquiring flight schedule information of a flight based on a pre-configured flight list;
determining and acquiring flight fuel data matching the flight schedule information of the flight;
collecting, by a pre-constructed data collection component, the flight schedule information of the flight and a matched flight fuel data based on a set data collection protocol; and
determining a fuel load planning center of gravity based on pre-configured fuel calculation parameters and the matched flight fuel data, to obtain a center of gravity index value of the flight.

According to at least one embodiment of the present disclosure, in the above method, the process of pre-configuring the flight list includes:
querying a flight matching a preset flight query condition; and
adding the flight into the flight list.

According to at least one embodiment of the present disclosure, in the above method, the process of pre-configuring the fuel calculation parameters includes:
adding setting items of aircraft static data, and generating a period of validity, wherein the flight takes effect within the period of validity; and
configuring and storing aircraft fuel calculation parameters in the setting items of the aircraft static data.

According to at least one embodiment of the present disclosure, in the above method, collecting, by a pre-constructed data collection component, the flight schedule information of the flight and a matched flight fuel data based on a set data collection protocol includes:
collecting, by the pre-constructed data collection component, the flight schedule information of the flight and the matched flight fuel data based on a preset condition and period for updating a load planning flight, and data content and a format of the flight schedule information and fuel quantity data during information transmission.

According to at least one embodiment of the present disclosure, in the above method, determining the fuel load planning center of gravity according to the pre-configured fuel calculation parameters and the matched flight fuel data, to obtain the center of gravity index value of the flight, includes:
determining, in a standard refueling mode, the fuel load planning center of gravity according to corresponding fuel calculation parameters and the matched flight fuel data in the standard refueling mode; and
determining, in a non-standard refueling mode, the fuel load planning center of gravity based on corresponding fuel calculation parameters and the matched flight fuel data in the non-standard refueling mode.

According to at least one embodiment of the present disclosure, in the above method, determining, in the standard refueling mode, the fuel load planning center of gravity based on the corresponding fuel calculation parameters and the matched flight fuel data in the standard refueling mode includes:
in response to a take-off fuel volume of a tail fuel tank being not separately provided, determining a take-off fuel volume influence index of an aircraft based on total take-off fuel volume data, a fuel density, and a flight standard refueling total fuel center of gravity index data table;
in response to the take-off fuel volume of the tail fuel tank being separately provided, calculating a take-off fuel volume influence index of the tail fuel tank based on the take-off fuel volume of the tail fuel tank and data in an aircraft tail fuel tank fuel center of gravity index data table, and determining take-off fuel volume influence indexes corresponding to the other fuel tanks by using the total take-off fuel volume of other fuel tanks which is determined based on the total take-off fuel volume and the take-off fuel volume of the tail fuel tank;
in response to an aircraft used by the flight not corresponding to data in a landing-dedicated fuel volume center of gravity index table, determining a total landing fuel volume based on the total take-off fuel volume and flight fuel consumption, and determining a landing fuel volume influence index of the aircraft based on the total landing fuel volume, the fuel density, and the flight standard refueling total fuel center of gravity index data table; and
in response to the aircraft used by the flight corresponds to the data in the landing-dedicated fuel volume center of gravity index table, determining the landing fuel volume influence index of the aircraft based on the data in the landing-dedicated fuel volume center of gravity index table.

According to at least one embodiment of the present disclosure, in the above method, determining, in the non-standard refueling mode, the fuel load planning center of gravity based on the corresponding fuel calculation parameters and the matched flight fuel data in the non-standard refueling mode includes:
in response to the take-off fuel volume of the tail fuel tank being not separately provided, determining the take-off fuel volume influence index of each fuel tank based on the take-off fuel volume of a split fuel tank of each fuel tank, and determining the take-off fuel volume influence index of the aircraft based on the take-off fuel volume influence index of each fuel tank;
in response to the take-off fuel volume of the tail fuel tank is separately provided, determining the take-off fuel volume influence index of the tail fuel tank based on the take-off fuel volume of the tail fuel tank and the fuel center of gravity index data table of the tail fuel tank, and determining the take-off fuel volume influence indexes corresponding to the other fuel tanks by using the total take-off fuel volume of other fuel tanks which is determined based on the total take-off fuel volume and the take-off fuel volume of the tail fuel tank; and
determining the landing fuel volume influence index of each fuel tank based on the landing fuel volume of the split fuel tank of each fuel tank, and determining the landing fuel volume influence index of the aircraft based on the landing fuel volume influence index of each fuel tank.

According to at least one embodiment of the present disclosure, the method further includes: after obtaining the center of gravity index value of the flight:
presenting the center of gravity index value of the flight in a graphical form.

According to at least one embodiment of the present disclosure, the present disclosure further provides an apparatus for collecting and processing flight fuel data, including:
an acquisition unit, configured to acquire flight schedule information of a flight based on a pre-configured flight list;
a fuel data determination unit, configured to determine and acquire flight fuel data matching the flight schedule information of the flight;
a collection unit, configured to collect, by a pre-constructed data collection component, the flight schedule information of the flight and a matched flight fuel data based on a set data collection protocol; and
a center of gravity index determination unit, configured to determine a fuel load planning center of gravity based on pre-configured fuel calculation parameters and the matched flight fuel data, to obtain a center of gravity index value of the flight.

According to at least one embodiment of the present disclosure, the present disclosure further provides a computer-readable medium, storing a computer program thereon, wherein the computer program includes program codes for executing the method for collecting and processing flight fuel data provided in any method embodiment mentioned above.

Compared with the prior art, the method and apparatus for collecting flight fuel data, and the computer-readable medium provided in the embodiments of the present disclosure at least flight fuel data the following technical advantages:
On one hand, the fuel data is automatically collected without the need for manual query and input, thereby reducing the workload of the load planner, and improving the efficiency of sending the flight fuel data; and manual operations are replaced with automatic processing to maximally reduce the error probability and to reduce the influence of human factors on an aircraft load planning process; and
on the other hand, regarding the calculation of the flight fuel data, which fuel tank is consumed is known based on fuel tank settings, thereby optimizing center of gravity calculation, improving the safety, reducing unnecessary fuel consumption, and providing personalized services. In the long run, aircraft load planning flights will increase year by year, and the increase in the aircraft load planning flights will inevitably require aircraft load planning inspection standards with higher efficiency and accurately, therefore it is only possible to better adapt to the increasingly developing aircraft market by using advanced technical solutions.

It should be noted that although the present theme has been described in language specific to structural features and/or methodological actions, it should be understood that the defined theme is not necessarily limited to the specific features or actions described above. Rather, the features and actions described above are merely example forms of implementing the defined theme.

Although several implementation details have been included in the above discussion, these should not be construed as limiting the scope of the present disclosure. Some features that are described in the context of separate embodiments may also be implemented in combination in a single embodiment. Conversely, various features that are described in the context of a single embodiment may also be implemented in a plurality of embodiments separately or in any suitable sub-combination.

What have been described above are only preferred embodiments of the present disclosure and illustrations of the technical principles employed. It should be understood by those skilled in the art that, the disclosure scope involved in the preset disclosure is not limited to the technical solutions formed by combinations of the above technical features, and meanwhile should also include other solutions formed by any combinations of the above technical features or equivalent features thereof without departing from the concept of the disclosure, for example, solutions formed by mutual replacement of the above features with technical features having similar functions disclosed in the present disclosure (but is not limited to).

What is claimed is:

1. A method for collecting and processing flight fuel data, comprising:
acquiring flight schedule information of a flight based on a pre-configured flight list;
determining and acquiring flight fuel data matching the flight schedule information of the flight;
collecting, by a pre-constructed data collection component, the flight schedule information of the flight and a matched flight fuel data based on a set data collection protocol; and
determining a fuel load planning center of gravity based on pre-configured fuel calculation parameters and the flight fuel data, to obtain a center of gravity index value of the flight.

2. The method as claimed in claim 1, wherein the process of pre-configuring the flight list comprises:
querying a flight matching a preset flight query condition; and
adding the flight into the flight list.

3. The method as claimed in claim 1, wherein the process of pre-configuring the fuel calculation parameters comprises:
adding setting items of aircraft static data, and generating a period of validity, wherein the flight takes effect within the period of validity; and
configuring and storing aircraft fuel calculation parameters in the setting items of the aircraft static data.

4. The method as claimed in claim 1, wherein collecting, by a pre-constructed data collection component, the flight schedule information of the flight and a matched flight fuel data based on a set data collection protocol comprises:
collecting, by the pre-constructed data collection component, the flight schedule information of the flight and the matched flight fuel data based on a preset condition and period for updating a load planning flight, and data content and a format of the flight schedule information and fuel volume data during information transmission.

5. The method as claimed in claim 1, wherein determining the fuel load planning center of gravity based on the pre-configured fuel calculation parameters and the flight fuel data, to obtain the center of gravity index value of the flight, comprises:
determining, in a standard refueling mode, the fuel load planning center of gravity based on corresponding fuel calculation parameters and flight fuel data in the standard refueling mode; and
determining, in a non-standard refueling mode, the fuel load planning center of gravity based on corresponding fuel calculation parameters and flight fuel data in the non-standard refueling mode.

6. The method as claimed in claim 5, wherein determining, in the standard refueling mode, the fuel load center of gravity based on the corresponding fuel calculation parameters and flight fuel data in the standard refueling mode comprises:
in response to a take-off fuel volume of a tail fuel tank being not separately provided, determining a take-off fuel volume influence index of an aircraft based on total take-off fuel volume data, a fuel density, and a flight standard refueling total fuel center of gravity index data table;
in response to the take-off fuel volume of the tail fuel tank being separately provided, calculating a take-off fuel volume influence index of the tail fuel tank based on the take-off fuel volume of the tail fuel tank and data in an aircraft tail fuel tank fuel center of gravity index data table, and determining take-off fuel volume influence indexes corresponding to the other fuel tanks by using the total take-off fuel volume of other fuel tanks which is determined based on the total take-off fuel volume and the take-off fuel volume of the tail fuel tank;
in response to an aircraft used by the flight not corresponding to data in a landing-dedicated fuel volume center of gravity index table, determining a total landing fuel volume based on the total take-off fuel volume and flight fuel consumption, and determining a landing fuel volume influence index of the aircraft based on the total landing fuel volume and the fuel density, and the flight standard refueling total fuel center of gravity index data table; and
in response to the aircraft used by the flight corresponding to the data in the landing-dedicated fuel volume center of gravity index table, determining the landing fuel volume influence index of the aircraft based on the data in the landing-dedicated fuel volume center of gravity index table.

7. The method as claimed in claim 6, wherein determining, in the non-standard refueling mode, the fuel load planning center of gravity based on the corresponding fuel calculation parameters and flight fuel data in the non-standard refueling mode comprises:
in response to the take-off fuel volume of the tail fuel tank being not separately provided, determining a take-off fuel volume influence index of each fuel tank based on the take-off fuel volume of a split fuel tank of each fuel tank, and determining the take-off fuel volume influence index of the aircraft based on the take-off fuel volume influence index of each fuel tank;
in response to the take-off fuel volume of the tail fuel tank being separately provided, determining the take-off fuel volume influence index of the tail fuel tank based on the take-off fuel volume of the tail fuel tank and the fuel center of gravity index data table of the tail fuel tank, and determining the take-off fuel volume influence indexes corresponding to the other fuel tanks by using the total take-off fuel volume of other fuel tanks which is determined based on the total take-off fuel volume and the take-off fuel volume of the tail fuel tank; and
determining the landing fuel volume influence index of each fuel tank based on the landing fuel volume of the split fuel tank of each fuel tank, and determining the landing fuel volume influence index of the aircraft based on the landing fuel volume influence index of each fuel tank.

8. The method as claimed in claim 1, after obtaining the center of gravity index value of the flight, further comprising:
presenting the center of gravity index value of the flight in a graphical form.

9. An apparatus for collecting and processing flight fuel data, comprising:
an acquisition unit, configured to acquire flight schedule information of a flight based on a pre-configured flight list;
a fuel data determination unit, configured to determine and acquire flight fuel data matching the flight schedule information of the flight;
a collection unit, configured to collect, by a pre-constructed data collection component, the flight schedule information of the flight and a matched flight fuel data based on a set data collection protocol; and
a center of gravity index determination unit, configured to determine a fuel load planning center of gravity based on pre-configured fuel calculation parameters and the flight fuel data, to obtain a center of gravity index value of the flight.

10. A computer-readable medium, storing a computer program thereon, wherein the computer program comprises program codes for executing the method according to any of claims 1-8.
